(19) United States
(12) Patent Application Publication
(10) Pub. No.: US 2011/0010315 A1
(43) Pub. Date: Jan. 13, 2011

(54) METHOD AND SYSTEM FOR RECOMMENDING ARTICLES

(75) Inventors: Julian PAAS, Ontario (CA); Biao WANG, Toronto (CA); Pendar YOUSEFI, Toronto (CA)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KIBBOKO, INC., Toronto (CA)

(21) Appl. No.: 12/501,221

(22) Filed: Jul. 10, 2009

(51) Int. Cl. G06N 5/02

(52) U.S. Cl. 706/11

(57) ABSTRACT

A computer-implemented method of providing recommendations for articles, includes receiving information regarding one or more articles; displaying a portion of the information received relating to the one or more articles, on a display device; receiving input from a user relating to the displayed information, from an input device, and displaying information on one or more new articles based on the user input.

### FIELD OF THE INVENTION

The present invention relates to an on-line method and system for recommending articles to users, based on user input.

### BACKGROUND TO THE INVENTION

A recommender system recommends articles to a user. In this patent application, “article” means any content, data or material that can be delivered on-line, and includes but is not limited to text, such as newspaper or magazine articles, books and book chapters, advertisements, videos, PowerPoints, audio files, podcasts, images, blogs, tweets, or products or services which could be provided or purchased.

Weaknesses of Current Recommender Systems for On-Line Articles. Current on-line recommendation systems for articles have a number of disadvantages and present a number of problems:

(a) Current Recommender Systems do not relate user input to recommendations in a visible and real-time (or near real-time) way. Currently available systems do little to promote engagement by the user. Typically the user is asked to provide user input in relation to an article, but there is no immediate connection between that input and the resulting recommendations. Also, users typically have no other choices to specify the kinds of content that they wish to have recommended. The user doesn't have fun in interacting with the system and receiving recommendations from it. As well, the user often has only a limited understanding about why particular recommendations are being made. Because the user cannot see how his or her input immediately influences the recommendation or selection of articles, the user may have reduced acceptance of, and confidence in, the recommender system. As well, many current systems are relatively impersonal—they simply tell a visitor that “people who read this article also read ______”, or “people who read this article bought ______”. They do not appear to be personalized to a great extent.

In many previous recommender systems, recommendations may only be generated between on-line sessions, and presented the next time the user logs on to the system. This decreases user engagement, fun and confidence in the system.

(b) Sparsely Rated Content. Where the number of articles and users are increasing or changing quickly, then there may be relatively few articles rated, and relatively few users providing ratings for any particular article. It can be challenging to provide effective and reliable recommendations for such sparsely rated content.

It is a goal of the present invention to address one or more the above-noted disadvantages and weaknesses of current recommender systems.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention is directed to a computer-implemented system and method of recommending articles, based on input from a user.

In one embodiment, the invention provides a computer-implemented method of providing recommendations for articles, comprising the steps: receiving information regarding one or more articles; displaying a portion of the information received relating to said one or more articles, on a display device; receiving input from a user relating to the displayed information, from an input device; and displaying information with information on one or more new articles based on the user input.

In a further embodiment of the invention, input received from the user is a rating of an article. In a further embodiment of the invention, the replaced portion of the displayed information is determined by the further following steps: determining an article rated favourably by the user; determining an article similar to an article rated favourably by the user; and, displaying information with information about the similar article.

In a further embodiment of the present invention, the step of determining an article similar to the article rated favourably by the user comprises the steps of: determining the frequency of words found in the article; determining the frequency of words found in a second article; determining with a computer processor a similarity metric based on the frequency of words found in article and the second article; and selecting a second article which meets a criteria to be the article similar to the article rated favourably by the user.

In a further embodiment of the present invention, the similarity metric is a cosine similarity metric.

In a further embodiment of the present invention, the criteria is the greatest value of the similarity metric.

In a further embodiment of the present invention, the criteria is a exceeding a threshold level.

In a further embodiment of the present invention, stop words in the article are not considered.

In a further embodiment of the present invention, the words in the article are stemmed.

In a further embodiment of the present invention, the user input is an unfavourable article rating, and the portion of information relating to this unfavourably rated article is replaced.

In a further embodiment of the present invention, further comprising the steps: receiving input from the user indicating that the user wishes to see a different article; and removing displayed information about an article.

In a further embodiment of the present invention, information on the new article is not displayed if a final date of publication has been exceeded, there is provided a computer-implemented system for providing recommendations for articles comprising: a display; an input device; a receiver module for receiving information regarding one or more articles; and a processor module, for determining replacement information to be displayed, based on the user input.

In a further embodiment of the present invention, the system further comprises a storage device for storing an article identifier for identifying an article, a user identifier for identifying a user, and a rating of the user for the article.

In a further embodiment of the present invention, the processor module determines a similarity between information presented in relation to the articles, and then determines the replacement information based on this similarity.

### LIST OF FIGURES

FIG. 1 shows a user interface in accordance with an embodiment of the present invention.

FIG. 2 shows a flow chart in accordance with an embodiment of the present invention.

FIG. 3 shows a block diagram in accordance with an embodiment of the present invention.

FIG. 4 shows a schematic computer system in accordance with an embodiment of the present invention.

FIG. 5 shows a block diagram of a computer system in accordance with an embodiment of the present invention.

### DETAILED DESCRIPTION OF THE INVENTION

It is a goal of the present invention to provide one or more of the following features or benefits:
(a) promote engagement by the user;
(b) promote increased acceptance of the recommender system;
(c) provide a recommender system which engenders greater user confidence;
(d) provide a recommender system that provides more immediate connection between user input and resulting recommendations;
(e) provide a recommender system that is more enjoyable and fun for the user;
(f) provide a recommender system that can recommend articles even when relatively few users have provided input on an article;
(g) provide a recommender system that increases page views of articles by users;
(h) recommends to users more of the kinds of articles that they like, and less of the ones that they don't like; and,
(i) provide a recommender system that increases time spent by users viewing articles.

As used in this application, the terms “step”, “module”, “component”, “model”, “system”, and the like are intended to refer to a computer-related entity, either hardware, a combination of hardware and software, software, or software in execution. For example, a module may be, but is not limited to being, a process running on a processor, a processor, an object, an executable, a thread of execution, a program, and/or a computer. By way of illustration, both an application running on a server and the server can be a module. One or more modules may reside within a process and/or thread of execution and a module may be localized on one computer and/or distributed between two or more computers. Also, these modules can execute from various computer readable media having various data structures stored thereon. The modules may communicate via local and/or remote processes such as in accordance with a signal having one or more data packets (e.g., data from one module interacting with another module in a local system, distributed system, and/or across a network such as the Internet with other systems via the signal).

The present invention is directed to a computer-implemented system and method interacting with users, and more specifically, for recommending on-line articles to users.

The system and method for recommending on-line articles or documents is suited for any computation environment. It may run in the background of a general purpose computer. In one aspect, it has CLI (command line interface), however, it could also be implemented with a GUI (graphical user interface) or together with the operation of a web browser.

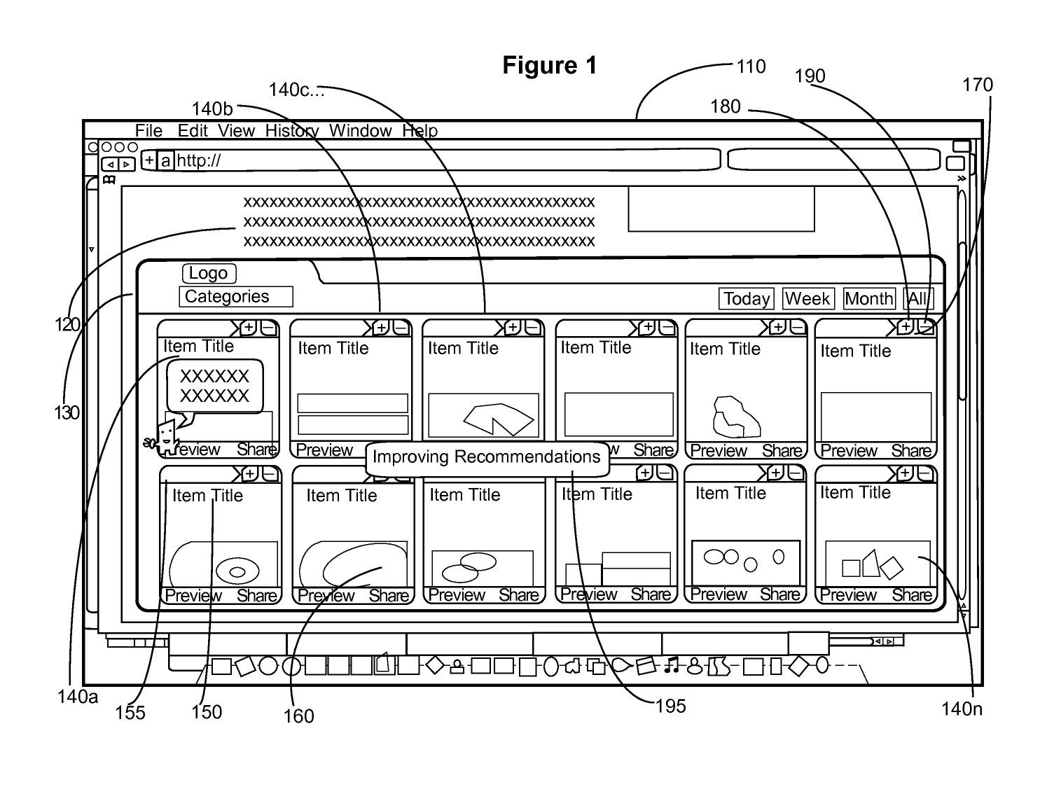

In an embodiment of the present invention, as is shown in FIG. 1, a user (not shown) views a display 110. The display, in a preferred embodiment shows an article or portion of an article currently being read, viewed or listened to 120. Also shown is a user recommendation widget 130. User recommendation widget 130 provides or displays information about one or more articles 140ₐ . . . 140ₙ that may be of interest to the user. In a preferred embodiment, the first article, 140ₐ, is the current article 120. The information about articles 140ₐ . . . 140ₙ may include a title 150, an image 160, or further text relating to the article (not shown). Associated with each article 140ₐ . . . 140ₙ may also be a label 155 which provides a category of the related article, such as “animals”, “current events”, “news”, “sports”, or provides further information about the article. Associated with each article 140ₐ . . . 140ₙ may be an on-line button 170 to facilitate receiving user input on the displayed article 140ₐ . . . 140ₙ. As is shown in FIG. 1, on-line button 170 comprises, in a preferred embodiment, a thumbs-up icon 180 and thumbs-down 190 icon. By clicking on the thumbs-up icon the user signals that they are favourably disposed towards the related article. Similarly, by clicking on the thumbs-down icon, the user signals that they are not favourably disposed towards the related article. User recommendation widget 130 may also contain a region 195 for display of further messages to the user. Alternatively, these further messages may be overlayed over the information about articles 140ₐ . . . 140ₙ.

Articles 140, . . . 140ₙ may comprise articles that are frequently viewed, listened to or read. They may also comprise articles that are new or more recent. In a preferred embodiment, the user may apply one or more filters (via a user interface which is not shown). These filters could select categories of articles a user is interested in, for example, only sports-related articles or no sports-related articles.

An important aspect of the present invention is that upon receiving input from the user on one or more of articles 140ₐ to 140ₙ the system and method, in the same session, provides one or more new (refreshed or replacement) articles to the user in place of one or more articles 140ₐ to 140ₙ. For example, in a preferred embodiment, where a user gives a thumbs-up to one or more of articles 140ₐ to 140ₙ the system and method will replace one or more articles 140ₐ to 140ₙ which a new article based on this user input. Similarly, in a preferred embodiment, where a user gives a thumbs-down to one or more of articles 140ₐ to 140ₙ, the system and method will replace one or more of articles 140ₐ to 140ₙ with a new article based on this user input. In a preferred embodiment, where the user gives a thumbs-up, one or more replacement articles are provided which are similar to the article given the thumbs-up.

Where an article is given a thumbs-down, one or more replacement articles are provided which are similar to an article previously given a thumbs-up. In a preferred embodiment, after an article is rated (given a thumbs-up or thumbs-down), it remains displayed until the user clicks on a related button or icon containing text such as “show another article”.

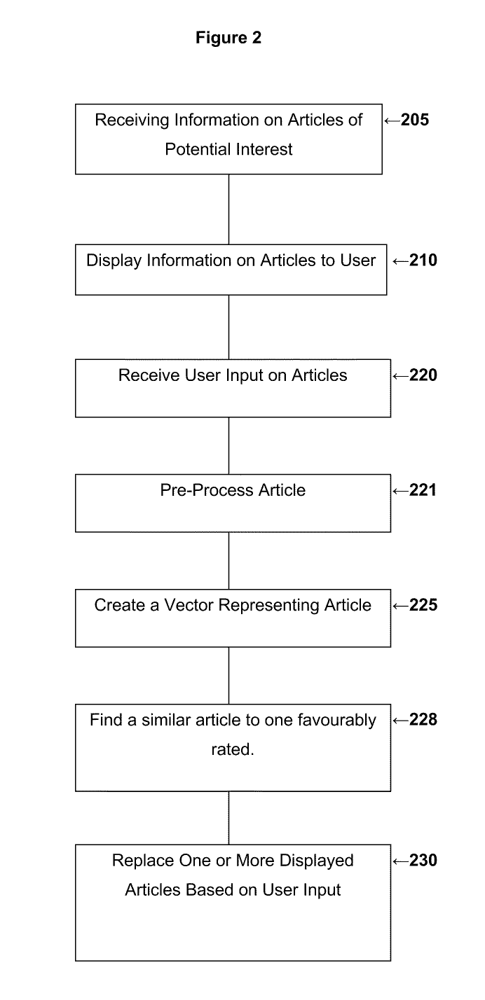

FIG. 2 provides a flow chart showing an embodiment of the present invention.

In step 205, information is received regarding articles of possible interest.

In step 210, information on articles of possible interest are displayed to a user.

In step 220, input is received from the user on one or more of the displayed articles. In a preferred embodiment of the present invention, this input is a click (via a mouse or other input device) on a thumbs-up or thumbs-down icon.

In step 230, one or more of the displayed articles (or information about them) is replaced, based on the user input. Typically, a new article or articles would be provided.

As mentioned above, in a preferred embodiment, when a user provides a thumbs-up, one or more similar articles are provided in user recommendation widget 130. These replace articles originally displayed in widget 130. In a preferred embodiment, a portion of articles 140ₐ to 140ₙ are used for this purpose.

The document receiving the thumbs-up may optionally be pre-processed in step 221. The data pre-processing 221 may comprise stop-word deletion, stemming and title and link extraction, which transforms or presents each article as a document vector in a bag-of-words data structure. With stop-word deletion, selected “stop” words (i.e. words such an “an”, “the”, “they” that are very frequent and do not have discriminating power) are excluded. The list of stop-words can be customized. Stemming converts words to the root form, in order to define words that are in the same context with the same term and consequently to reduce dimensionality. Such words may be stemmed by using Porter's Stemming Algorithm but other stemming algorithms could also be used. Text in links and titles from web pages can also be extracted and included in a document vector.

For each document, in step 225 of the invention a vector is created, setting out the frequency of occurrence of each of the words found in the article. In other words for each article of interest a vector is created {F₁, F₂, . . . F_{X}}, where F₁ represents the frequency in the document of the word, W₁. Where a word is not found in the article, the frequency is zero.

In a preferred embodiment, the vector may only be created for a portion of the article, such as the title and first paragraph, or for a brief description or abstract of it.

Vectors are then created using the same words, to represent other potentially similar articles. Then the vectors are compared in step 228 to determine those most similar. In a preferred embodiment, cosine similarity may be used to compare the two article vectors.

For example:

$$Article 1 words \text{:} \begin{matrix} {W}_{1} , & {W}_{2} , & {W}_{3} , & {W}_{4} … & {W}_{n}\end{matrix}$$

$$\# of occurrences \begin{matrix} 6 , & 3 , & 2 , & 1 , … & 1\end{matrix}$$

$$Article 2 \# of \begin{matrix} 3 , & 0 , & 1 , & 0 , … & 0\end{matrix}$$

$$occurrences$$

$$Similarity = \frac{\begin{matrix}\sum \# of occurrences {W}_{n} in article 1 \times \\ \# of occurrences of {W}_{n} in article 2\end{matrix}}{\sqrt{{W}_{n}^{2} in Article 1} \times \sqrt{{W}_{n}^{2} in Article 2}}$$

For example:

$$Similarity = \frac{6 \cdot 3 + 3 \cdot 0 + 2 \cdot 1 + 1 \cdot 0 … + 1 \cdot 0}{\sqrt{{6}^{2} + {3}^{2} + {2}^{2} + {1}^{2} … {1}^{2}} \cdot \sqrt{{3}^{2} + {0}^{2} + {1}^{2} + {0}^{2} … {0}^{2}}}$$

Other measures of similarity are also possible for example:

(a) Sørensen's quotient of similarity

(b) Mountford's index of similarity

(c) Hamming distance

(d) Correlation

(e) Dice's coefficient

(f) Jaccard index

(g) SimRank

(h) Information retrieval

(i) Weighted cosine measure

In a preferred embodiment, the publisher of articles, such as a newspaper publisher, provides the information which is received in step 205. In a preferred embodiment, this is provided via an extension to the RSS feed version 2.0. For each article, the publisher can preferably provide the following information:

(a) article title;

(b) article URL;

(c) article text;

(d) article category;

(e) the URL of a thumbnail image;

(f) article ID; and,

(g) a final date of publication.

In a preferred embodiment, articles (or information about them) are not displayed after the final date of publication received from the publisher.

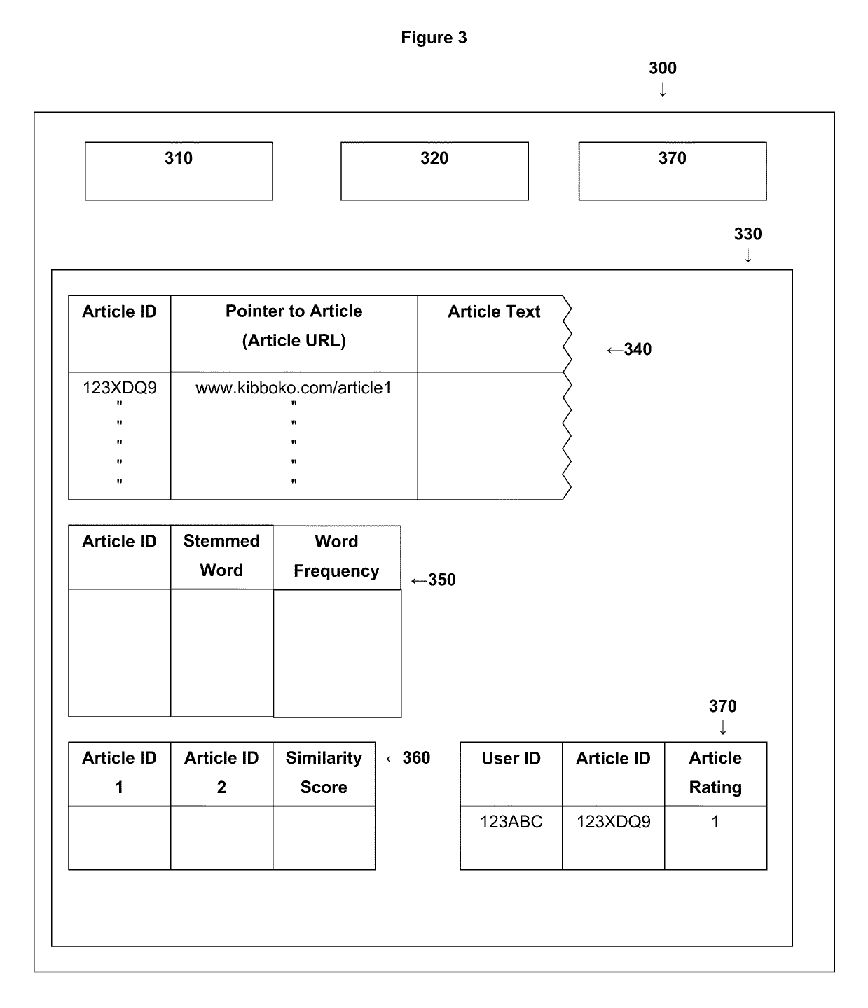

Further information on the RSS specification can be found at http://cyber.law.harvard.edu/rss/rss.html. In a preferred embodiment, the information from this RSS feed is stored on table 340 as partially shown in FIG. 3. Alternatively, this information can be received in various other ways, including via spreadsheets or can be acquired by web robots.

In a preferred embodiment, related to each article is a table, stored in a database, which stores stemmed words and the associated word count for each article. This is shown in FIG. 3.

FIG. 3 shows a recommender system 300, which contains a display 310 and user input device 320. Recommender system 300 also contains a database 330 with a number of tables, such as table 340 which is described above. Database 330 also contains table 350 which provides for each article ID, a list of stemmed words and the frequency each stemmed word appears in the article identified word.

In a preferred embodiment, each user is given a unique user ID, which is stored as a cookie on the user's computer system. Database 330 also contains a table 370, which sets out information such as the user ID, article ID, and the input or rating received on the article.

In a preferred embodiment, database 330 also contains a table which stores the IDs for first and second articles and the associated similarity score.

The format of tables described as occurring in database 330 are exemplary only—other formats are possible and within the scope of the present invention.

Recommender system 300 also contains a CPU 370 for calculating similarity scores and for carrying out other tasks.

When a user gives one or more of articles 140ₐ . . . 140ₙ a less favourable rating, for example, a thumbs-down, the system then checks table 370 and determines a previous article given a more favourable rating. One or more articles (or information about them) similar to a previously favourably rated article is then displayed to the user. The displayed articles will be ones meeting a specified criteria. The most similar article or articles may be displayed as replacement articles. Alternatively, articles exceeding a threshold level of the similarity metric may be displayed.

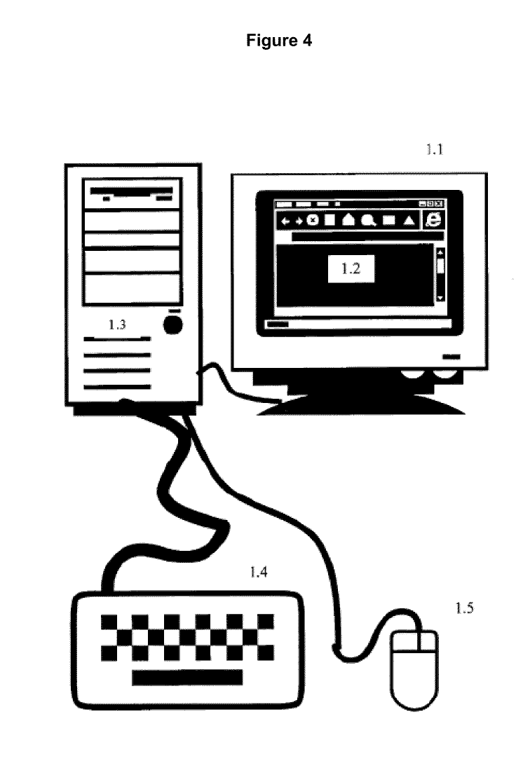

FIG. 4 shows a general computer system on which the invention might be practiced. The general computer system comprises of a display device (1.1) with a display screen (1.2). Examples of display device are Cathode Ray Tube (CRT) devices, Liquid Crystal Display (LCD) Devices etc. The general computer system can also have other additional output devices like a printer. The cabinet (1.3) houses the additional basic components of the general computer system such as the microprocessor, memory and disk drives. In a general computer system the microprocessor is any commercially available processor of which x86 processors from Intel and 680X0 series from Motorola are examples. Many other microprocessors are available. The general computer system could be a single processor system or may use two or more processors on a single system or over a network. The microprocessor for its functioning uses a volatile memory that is a random access memory such as dynamic random access memory (DRAM) or static memory (SRAM). The disk drives are the permanent storage medium used by the general computer system. This permanent storage could be a magnetic disk, a flash memory and a tape. This storage could be removable like a floppy disk or permanent such as a hard disk. Besides this the cabinet (1.3) can also house other additional components like a Compact Disc Read Only Memory (CD-ROM) drive, sound card, video card etc. The general computer system also had various input devices like a keyboard (1.4) and a mouse (1.5). The keyboard and the mouse are connected to the general computer system through wired or wireless links. The mouse (1.5) could be a two-button mouse, three-button mouse or a scroll mouse. Besides the said input devices there could be other input devices like a light pen, a track ball, etc. The microprocessor executes a program called the operating system for the basic functioning of the general computer system. The examples of operating systems are UNIX™, WINDOWS™ and OS X™. These operating systems allocate the computer system resources to various programs and help the users to interact with the system. It should be understood that the invention is not limited to any particular hardware comprising the computer system or the software running on it.

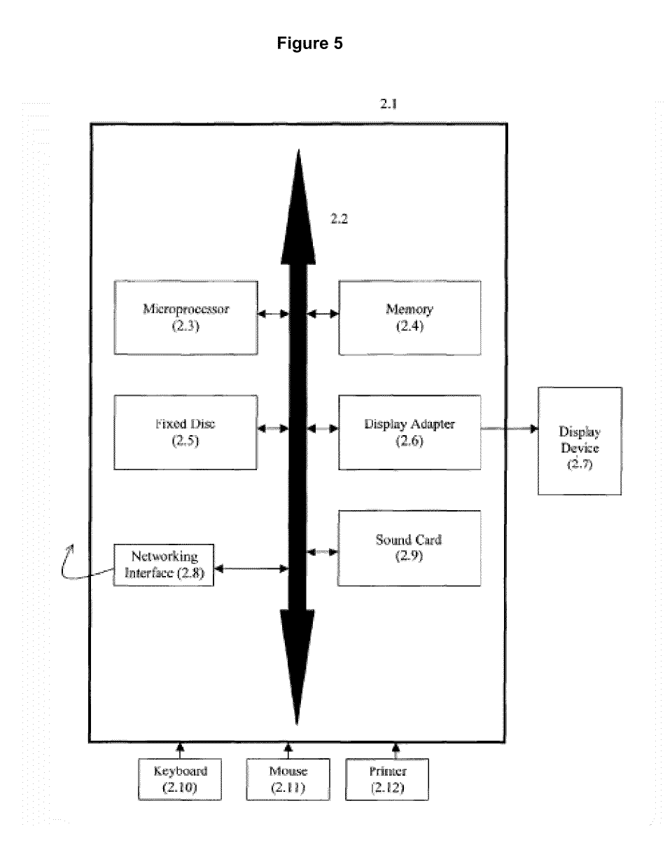

FIG. 5 shows the internal structure of the general computer system of FIG. 5. The general computer system (2.1) consists of various subsystems interconnected with the help of a system bus (2.2). The microprocessor (2.3) communicates and controls the functioning of other subsystems. Memory (2.4) helps the microprocessor in its functioning by storing instructions and data during its execution. Fixed Drive (2.5) is used to hold the data and instructions permanent in nature like the operating system and other programs. Display adapter (2.6) is used as an interface between the system bus and the display device (2.7), which is generally a monitor. The network interface (2.8) is used to connect the computer with other computers on a network through wired or wireless means. The system is connected to various input devices like keyboard (2.10) and mouse (2.11) and output devices like printer (2.12). Various configurations of these subsystems are possible. It should also be noted that a system implementing the present invention might use less or more number of the subsystems than described above. The computer screen which displays the recommendation results can also be a separate computer system than that which contains components such as database 360 and the other modules described above.

In a preferred embodiment, the computer system will include a receiver module for receiving information regarding one or more articles. The system will also include a processor module, for determining replacement information to be displayed, based on the user input.

What has been described above includes examples of the present invention. It is, of course, not possible to describe every conceivable combination of components or methodologies for purposes of describing the present invention, but one of ordinary skill in the art may recognize that may further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A computer-implemented method of providing recommendations for articles, comprising the steps:
(a) receiving information regarding one or more articles;
(b) displaying a portion of the information received relating to said one or more articles, on a display device;
(c) receiving input from a user relating to the displayed information, from an input device; and,
(d) displaying information with information on one or more new articles based on the user input.

2. The method of claim 1 where the input received from the user is a rating of an article.

3. The method of claim 1 where the replaced portion of the displayed information is determined by the further following steps:
(a) determining an article rated favourably by the user;
(b) determining an article similar to an article rated favourably by the user on a computer processor; and,
(c) displaying information with information about the similar article.

4. The method of claim 3 where the step of determining an article similar to the article rated favourably by the user comprises the steps of:
(a) determining the frequency of words found in the article;
(b) determining the frequency of words found in a second article;
(c) determining a similarity metric based on the frequency of words found in article and the second article;
(d) selecting a second article which meets a criteria to be the article similar to the article rated favourably by the user.

5. The method of claim 4 where the similarity metric is a cosine similarity metric.

6. The method of claim 4 where the criteria is the greatest value of the similarity metric.

7. The method of claim 4 where the criteria is a exceeding a threshold level.

8. The method of claim 4 where stop words in the article are not considered.

9. The method of claim 4 where the words in the article are stemmed.

10. The method of claim 3 where the user input is an unfavourable article rating, and the portion of information relating to this unfavourably rated article is replaced.

11. The method of claim 1 further comprising the steps:
(a) receiving input from the user indicating that the user wishes to see a different article; and,
(b) removing displayed information about an article.

12. The method of claim 1 where information on the new article is not displayed if a final date of publication has been exceeded.

13. A computer-implemented system for providing recommendations for articles comprising,
a) a display;
b) an input device;
c) a receiver module for receiving information regarding one or more articles; and,
d) a processor module, for determining replacement information to be displayed, based on the user input.

14. The system of claim 13 further comprising a storage device for storing an article identifier for identifying an article, a user identifier for identifying a user, and a rating of the user for the article.

15. The system of claim 13 where the processor module determines a similarity between information presented in relation to the articles, and then determines the replacement information based on this similarity.
